(19) United States
(12) Patent Application Publication
(10) Pub. No.: US 2025/0229805 A1
(43) Pub. Date: Jul. 17, 2025

(54) ROAD-RISK AWARENESS SYSTEM (RAS) IN SEMI OR FULLY AUTONOMOUS VEHICLES

(71) Applicant: FLORIDA ATLANTIC UNIVERSITY BOARD OF TRUSTEES, Boca Raton, FL (US)

(72) Inventors: Mehrdad Nojoumian, Boca Raton, FL (US); Lars Skaug, Boca Raton, FL (US)

(21) Appl. No.: 19/016,485

(22) Filed: Jan. 10, 2025

Related U.S. Application Data
(60) Provisional application No. 63/620,353, filed on Jan. 12, 2024.

(51) Int. Cl. B60W 60/00; B60W 50/00; G01C 21/00; G01C 21/34; G06Q 40/08

(52) U.S. Cl. CPC B60W 60/0015; B60W 50/0097; G01C 21/3461; G01C 21/3859; G06Q 40/08; B60W 2420/403; B60W 2520/06; B60W 2520/10; B60W 2552/05; B60W 2556/10; B60W 2556/65

(57) ABSTRACT

Systems, methods, and devices described herein can be used to determine a predictive output indicative of a risk measure for a vehicle's geographic location, where the vehicle may be part of a cooperative vehicle system. An example vehicle system can be configured to: monitor a vehicle's geographic location; obtain data corresponding with the vehicle's geographic location; determine a predictive output indicative of a risk measure for the vehicle's geographic location; and in response to identifying an above-threshold predictive output for the at least one vehicle's geographic location, determine an optimal vehicle route, generate an alert, and/or trigger a corrective operation.

### CROSS-REFERENCE TO RELATED APPLICATIONS

This application claims priority to and the benefit of U.S. Provisional Application No. 63/620,353, titled “ROAD-RISK AWARENESS SYSTEM (RAS) IN SEMI OR FULLY AUTONOMOUS VEHICLES,” filed on Jan. 12, 2024, the content of which is hereby incorporated by reference herein in its entirety.

### BACKGROUND

There is increasing demand and adoption of autonomous robotic systems (e.g., autonomous vehicles (AVs), surgical robots, care-giving robots, and the like) and vision systems. However, many existing systems are plagued by technical challenges and limitations. For example, public concerns about the safety of autonomous vehicles are driving demand for technologies that can reduce accidents. Additionally, there are various concerns regarding the safety of operating autonomous vehicles on public roads and a lack of standardization in such technologies.

As such, there is a need for improved safety and reliability of such systems. These needs and others are at least partially satisfied by the present disclosure.

### SUMMARY

Disclosed herein are systems, methods, and devices that can be used to warn autonomous vehicles of potential hazards including traffic conditions. In some examples, the systems described herein leverage the increasing availability of data from various sources (e.g., Internet of Things (IoT) devices, AV sensors vehicle crash reports, and real time data such as weather data, vehicle speed, sun glare, and the like) to support crowdsourcing in road hazard intelligence to increase occupant safety and prevent accidents. Embodiments of the present disclosure support navigation guidance systems that consider the risk of each of a plurality of potential navigation paths and select a navigation path that minimizes such risks at the least possible cost in terms of distance and time (e.g., an optimal navigation path or low-risk navigation path).

In some embodiments, a Road-Risk Awareness System (RAS) in semi or fully autonomous vehicles is provided. The example system can include: (1) cloud and/or local storage to collect real-time data from various sources regarding prior accidents and road incidents on a periodic or ongoing basis; (2) cloud computing infrastructures and existing AV computing devices to analyze data using machine learning and artificial intelligence; and (3) algorithms to quantify the risk factors in terms of scores, analyze driver behavior (e.g., based on accident reports), update or mark a map, determine optimal vehicle routes, and finally, to inform the semi or fully autonomous vehicle(s) regarding potential risks through existing communication platforms. In some examples, the system can provide a warning to the operator of a vehicle to take over immediately in the event of a determined high-risk factor above a certain threshold corresponding with the vehicle's geographic location. The system can also associate the risk with a level of vehicle autonomy. Additionally, the system can define the common reasons for accidents in a specific location and time frame and then process them for each level of autonomy. The system can predict risk factors and scores in terms of time and location based on static (e.g., road condition) as well as active (e.g., population change) factors using machine learning and artificial intelligence (AI) techniques. Finally, the system can share this information with other vehicles in a connected or cooperative driving context. The data can be obtained from different sources, including but not limited to, government agencies (e.g., Federal Department of Transportation, National Transportation Safety Board (NTSB), National Highway Traffic Safety Administration (NHTSA) and the like).

In some implementations, a driving system is provided. The driving system can include: at least one vehicle, the at least one vehicle including: at least one processor (e.g., cloud-based processing system) in electronic communication with the at least one vehicle; and a memory having instructions thereon, wherein the instructions when executed by the processor, cause the processor to: monitor the at least one vehicle's geographic location; obtain data corresponding with the at least one vehicle's geographic location; determine a predictive output indicative of a risk measure for the at least one vehicle's geographic location; and in response to identifying an above-threshold predictive output for the at least one vehicle's geographic location, determine an optimal vehicle route, generate an alert, and/or trigger a corrective operation.

In some implementations, the instructions when executed by the processor cause the processor to further: provide a recommendation for a driver of the at least one vehicle to modify the at least one vehicle's route.

In some implementations, the corrective operation includes causing the at least one vehicle to modify its route and/or modify a vehicle driving mode (e.g., deactivate an autonomous driving mode).

In some implementations, the predictive output is determined using a machine learning model.

In some implementations, the machine learning model is a neural network model.

In some implementations, the instructions when executed by the processor cause the processor to further: determine a confidence measure in relation to the above-threshold predictive output; and generate the alert or trigger the corrective operation (e.g., deactivate autonomous driving mode) in an instance in which the confidence measure meets or exceeds a predetermined threshold.

In some implementations, the confidence measure is determined based, at least in part, on real-time vehicle data obtained from one or more other vehicles.

In some implementations, the instructions when executed by the processor cause the processor to further: transmit an indication of the above-threshold predictive output to another apparatus (e.g., another vehicle) that is within a predetermined range of the at least one vehicle or to a central server.

In some implementations, the predictive output is determined based, at least in part, on at least one of historical weather conditions, current weather conditions, time of year, historical accident data corresponding with the vehicle's geographic location and/or real-time or historical vehicle data (e.g., from the vehicle or one or more other vehicles).

In some implementations, the real-time vehicle data includes at least one of a vehicle speed, temperature, direction of travel, and vehicle path deviation/variance (e.g., swerving).

In some implementations, the predictive output is determined based, at least in part, on data obtained from one or more databases (e.g., public databases).

In some implementations, the predictive output is determined based, at least in part, on historical vehicle data for a plurality of other vehicles.

In some implementations, the vehicle's geographic location includes one or more public and/or private roads.

In some implementations, the predictive output is used to update one or more existing maps and/or navigation systems.

In some implementations, the vehicle data is used to determine a proportion of time spent by the at least one vehicle in geographic locations with corresponding above-threshold risk values, and wherein the determined proportion of time is used to determine an insurance premium for the at least one vehicle.

In some implementations, the at least one vehicle is an autonomous or semi-autonomous vehicle.

In some implementations, a cooperative driving system is provided. The system can include: a plurality of vehicles in electronic communication with one another, each vehicle including: at least one image sensor; a processor in electronic communication with the at least one image sensor; and a memory having instructions thereon, wherein the instructions when executed by the processor, cause the processor to: monitor each vehicle's geographic location; obtain data corresponding with the vehicle's geographic location; determine a predictive output indicative of a risk measure for each vehicle's geographic location; and in response to identifying an above-threshold predictive output for a particular vehicle's current geographic location, determine an optimal vehicle route, generate an alert, and/or trigger a corrective operation, wherein each of the plurality of vehicles is configured to transmit an indication of detected above-threshold predictive outputs to at least another vehicle and/or trigger corrective operations in relation to the at least another vehicle.

In some implementations, each of the plurality of vehicles is configured to transmit the indication of detected above-threshold predictive outputs to at least another vehicle and/or trigger corrective operations in relation to the at least another vehicle when it is within a predetermined range.

In some implementations, each vehicle is an autonomous or semi-autonomous vehicle.

In some implementations, a method for determining a risk measure for a vehicle's geographic location is provided. The method can include: monitoring the vehicle's geographic location; periodically determining a predictive output indicative of the risk measure for the vehicle's geographic location; and in response to identifying an above-threshold predictive output for the vehicle's geographic location, determine an optimal vehicle route, generate an alert, and/or trigger a corrective operation.

In some implementations, a non-transitory computer readable medium is provided. The non-transitory computer readable medium can include a memory having instructions stored thereon to perform any of the systems or methods described herein.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF DRAWINGS

The components in the drawings are not necessarily to scale relative to each other. Like reference, numerals designate corresponding parts throughout the several views.

FIG. 1 is an example system in accordance with certain embodiments of the present disclosure.

FIG. 2 is flowchart diagram illustrating a method in accordance with certain embodiments of the present disclosure.

FIG. 3 is an example system in accordance with certain embodiments of the present disclosure.

FIG. 4 is an example computing device.

### DETAILED DESCRIPTION

It is appreciated that certain features of the disclosure, which are, for clarity, described in the context of separate embodiments, can also be provided in combination with a single embodiment. Conversely, various features of the disclosure, which are, for brevity, described in the context of a single embodiment, can also be provided separately or in any suitable subcombination. Unless defined otherwise, all technical and scientific terms used herein have the same meaning as commonly understood by one of ordinary skill in the art. Methods and materials similar or equivalent to those described herein can be used in the practice or testing of the present disclosure.

### Definitions

In this specification and in the claims that follow, reference will be made to a number of terms, which shall be defined to have the following meanings:

Throughout the description and claims of this specification, the word “comprise” and other forms of the word, such as “comprising” and “comprises,” means including but not limited to, and are not intended to exclude, for example, other additives, segments, integers, or steps. Furthermore, it is to be understood that the terms comprise, comprising, and comprises as they relate to various embodiments, elements, and features of the disclosure also include the more limited embodiments of “consisting essentially of” and “consisting of.”

As used herein, the singular forms “a,” “an,” and “the” include plural referents unless the context clearly dictates otherwise. Thus, for example, reference to a “sensing device” includes embodiments having two or more such sensing devices unless the context clearly indicates otherwise.

Ranges can be expressed herein as from “about” one particular value and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It should be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

For the terms “for example” and “such as,” and grammatical equivalences thereof, the phrase “and without limitation” is understood to follow unless explicitly stated otherwise.

As used herein, the terms “data,” “content,” “information,” and similar terms may be used interchangeably to refer to data capable of being transmitted, received and/or stored in accordance with embodiments of the present invention.

Embodiments of the present disclosure provide methods and systems for determining a predictive output/risk measure for a vehicle's geographic location that may be part of a cooperative vehicle system. In some examples, the system obtains data from a plurality of sources and analyzes the data to determine a predictive output indicative of a risk measure. In response to detecting an above-threshold predictive output, the system can trigger an alert or corrective operation, including transmitting indications of above-threshold predictive outputs to other apparatuses.

### Example System

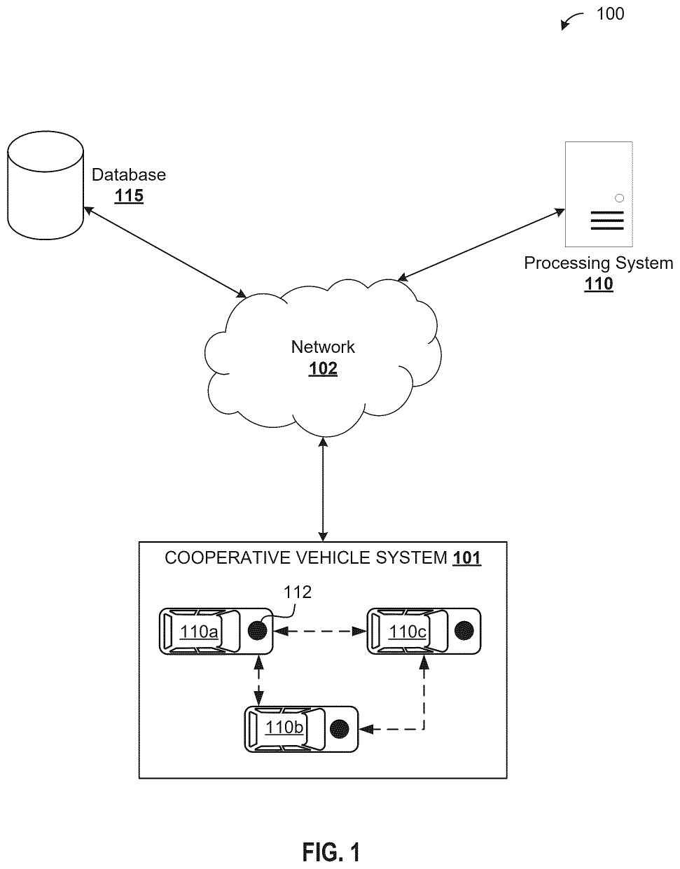

FIG. 1 is an example system 100 in accordance with certain embodiments of the present disclosure. As shown in FIG. 1, the system 100 includes a processing system 110 or device (e.g., cloud-based processing system) configured to communicate with a cooperative vehicle system 101 (also referred to herein as a cooperative driving system). In various implementations, the processing system 110 and the cooperative vehicle system 101 are configured to transmit data to and receive data from one another over a network 102. The system 100 can include one or more databases, data stores, repositories, and the like. As shown, the system 100 includes database(s) 115 in communication with the cooperative vehicle system 101 and the processing system 110. In some implementations, the database(s) 115 can be hosted by the processing system 110.

In some implementations, as illustrated, the cooperative vehicle system 101 comprises a plurality of cooperative vehicles 110a, 110b, 110c (e.g., autonomous vehicles, semi-autonomous vehicles, or combinations thereof) in electronic communication with one another. For example, the cooperative vehicle system 101 can comprise a plurality of autonomous vehicles each using machine vision operations/techniques to navigate its environment. The present disclosure contemplates that the cooperative vehicle system 101 is not limited to the example depicted in FIG. 1 and can comprise surgical robots, care-giving robots, drone systems, and/or the like in electronic communication with one another.

As further described herein, each of the plurality of cooperative vehicles 110a, 110b, 110c can include one or more sensing devices configured to monitor and/or obtain real-time information/data from the environment (e.g., image data, video data, audio data, vehicle data, body data from one or more individuals, environmental data (e.g., temperature, pressure) and the like). For example, as shown, the first cooperative vehicle 110a comprises at least one sensing device 112. The sensing device(s) 112 can be or comprise one or more optical devices, advanced cameras and/or sensors that may utilize high dynamic range (HDR) imaging and adaptive exposure control. The example sensing device(s) 112 can also include infrared cameras, light detection and ranging (LiDAR) sensor(s), short range radio detection and ranging (RADAR) sensor(s), or combinations thereof.

By way of example, each of the plurality of cooperative vehicles 110a, 110b, 110c can be configured to obtain data from its environment that can in turn be used to determine a predictive output indicative of a risk measure corresponding with the vehicle's current geographic location. Further, each of the plurality of cooperative vehicles 110a, 110b, 110c can generate and transmit indications of the determined predictive outputs to one or more other vehicles within a predetermined range. These indications can be used to trigger corrective operations in relation to the other vehicles. In some implementations, a given vehicle can transmit such information to a server (e.g., processing system 110) where it may be stored in a database 115 for subsequent analysis, to update one or more maps, and/or used to generate and send indications to vehicles in communication therewith or in response to requests for such information.

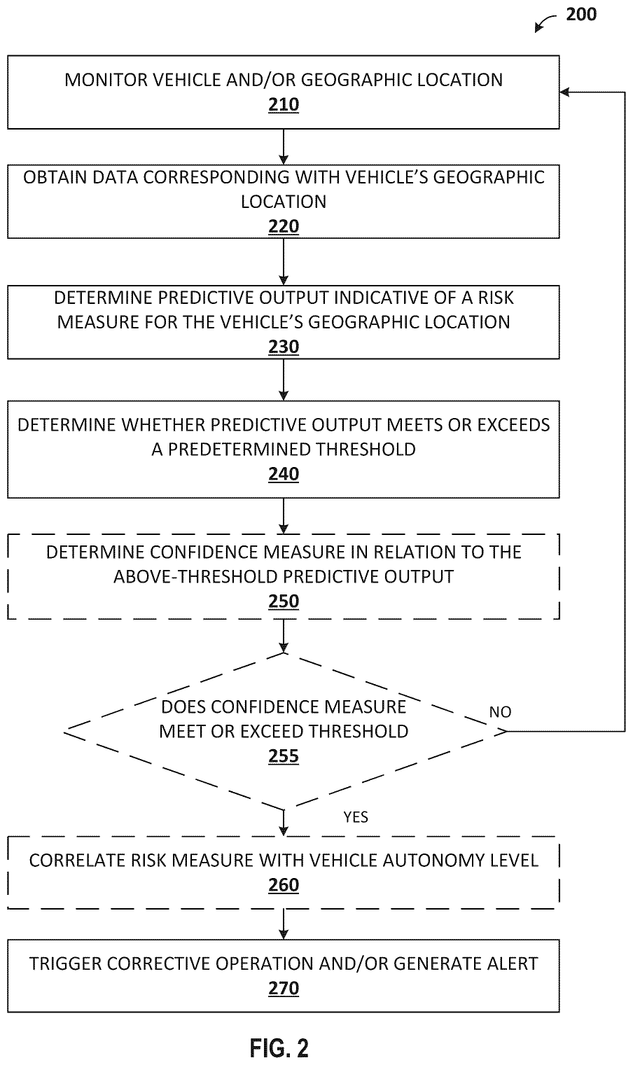

Referring now to FIG. 2, a flowchart diagram depicting a method 200 for determining predictive outputs that can be used to determine a vehicle autonomy level, trigger corrective operations, and/or generate alerts is shown. This disclosure contemplates that the example method 200 can be performed using one or more computing devices (e.g., at least the configuration illustrated in FIG. 4 by box 402) and/or at least partially by a cooperative vehicle system 101 described in connection with FIG. 1.

At step/operation 210, the method 200 includes monitoring a vehicle, for example, the vehicle's geographic location/the vehicle's environment. In some implementation, step/operation 210 includes obtaining data, such as, but not limited to, image data/video data via at least one sensing device 112 described above in connection with FIG. 1. As described above, the at least one sensing device 112 may be operatively coupled to or a component of a cooperative vehicle system such as an autonomous vehicle or semi-autonomous vehicle. The at least one sensing device 112 can be or comprise one or more optical devices, image sensors, location sensors (such as a global positioning system (GPS) sensor), camera(s), two dimensional (2D) and/or three dimensional (3D) light detection and ranging (LiDAR) sensor(s), long, medium, and/or short range radio detection and ranging (RADAR) sensor(s), ultrasonic sensors, electromagnetic sensors, (near-) infrared (IR) cameras, 3D cameras, 360° cameras, accelerometer(s), gyroscope(s), and/or other sensors that enable the vehicle to determine one or more features of the corresponding surroundings, and/or other components configured to perform various operations, procedures, functions or the like described herein. In some implementations, the method 200 includes obtaining real-time or historical vehicle data from the vehicle and/or for one or more other vehicles. The real-time vehicle data can include at least one of a vehicle speed, temperature, direction of travel, and vehicle path deviation/variance (e.g., swerving).

At step/operation 220, the method 200 includes obtaining (e.g., requesting, retrieving) data corresponding with the vehicle's geographic location, for example, from one or more databases (e.g., public databases, private databases). The vehicle's geographic location can be a one or more private roads and/or public roads. Such data can include historical weather conditions, current weather conditions, time of year data, and/or historical accident data corresponding with the vehicle's geographic location.

At step/operation 230, the method 200 includes determining a predictive output indicative of a risk measure for the vehicle's geographic location. In various examples, step/operation 230 is performed periodically or in response to a received request (e.g., from an onboard vehicle navigation system or a cloud-based processing system). In some implementations, the method 200 includes determining the predictive output based, at least in part, on real-time data from the vehicle, real-time data from one or more other vehicles, and/or at least a portion of the data retrieved from the database(s). For example, such information can be used to determine a predictive output that is indicative of a likelihood that the vehicle is in a geographic location or position where it is likely to have an accident and/or experience poor road conditions (e.g., heavy rain, poor visibility, slippery roads, or the like).

At step/operation 240, the method 200 includes determining whether the predictive output meets or exceeds a predetermined threshold value. For example, if the predictive output is a risk score of 80% and the predetermined threshold is 75%, the system determines that the predictive output meets the predetermined threshold. Conversely, in the above example, if the predictive output is 60%, then the system determines that the predictive output fails to meet the predetermined threshold value and may take no further action.

Optionally, at step/operation 250, the method 200 includes determining a confidence measure in relation to the predictive output. In some implementations, the method 200 includes determining the confidence measure based, at least in part, on data (e.g., vehicle data) obtained from one or more other apparatuses or computing devices (e.g., vehicles, databases, or the like). Accordingly data from other sources (e.g., databases, vehicles) can be used to confirm or validate an above-threshold predictive output.

Optionally, at step/operation 255, the method 200 includes determining whether the determined confidence measure meets or exceeds a predetermined threshold value. By way of example, the system can retrieve additional data (e.g., from one or more databases, one or more other computing devices, AVs, or the like) and analyze the additional data to confirm or validate the determined confidence measure. Advantageously, additional data can be obtained and processed only when necessary for making a determination (e.g., in an instance in which the confidence measure is close to or within a certain range of the threshold value) in order to conserve computational resources. By way of example, if the determined confidence measure is close to, but does not meet or exceed, the threshold value, the computing device can retrieve historical data for the vehicle's geographic location. The computing device can use such information to determine whether there is a high history of accidents or poor road conditions corresponding with the vehicle's geographic location that can be used to validate or invalidate the confidence measure. If the geographic location is associated with many historical accidents relative to other similar or nearby geographic locations, then the confidence measure can be validated or confirmed even where the determined value does not meet or exceed the predetermined threshold. If the determined confidence measure does not meet or exceed the predetermined threshold, then the method 200 returns to step/operation 210.

Optionally, in some implementations, at step/operation 260, the method 200 includes correlating the risk measure with a vehicle autonomy level. For example, in response to determining an above-threshold predictive output or a predictive output within a predetermined range, the system can determine an optimal vehicle route. The system can determine optimal vehicle routes that can be used by navigation systems for route planning purposes. In various examples, analysis of historical road data can be used to minimize risks for a driver and/or AV. By way of example, system outputs can be included as a user-selectable navigation system feature (e.g., “minimize navigation risks,” similar to “avoid highways” or “avoid toll roads”). System outputs can also be utilized to inform other third-party systems (e.g., road construction companies, insurance companies, Departments of Transportation, and the like). In some implementations, the system can automatically modify a vehicle's driving mode or route (e.g., deactivate an autonomous driving mode for an above-threshold predictive output or active an autonomous driving mode for a below-threshold predictive output).

At step/operation 270, the method 200 includes triggering a corrective operation in an instance in which the predictive output and/or confidence measure satisfies, meets, or exceeds the predetermined threshold value(s). A corrective operation can include changing the vehicle's driving mode, causing the vehicle to modify its route (e.g., avoid one or more private or public roads), generating a corresponding recommendation, generating an alert, or combinations thereof. As noted above, the system can also associate the risk with the level of autonomy. For example, the system can define the common reasons for accidents in a specific location and time-frame and then process them for each level of autonomy. The system can predict the risk factors and/or scores in terms of time and location based on static (e.g., road condition) as well as active (e.g., population change) factors using machine learning and AI techniques and share this information with other vehicles in a connected or cooperative driving context. In some implementations, the system uses the predictive output to update one or more existing maps and/or navigation systems. The corrective operation can include providing a warning to the operator of a vehicle to take over immediately (e.g., deactivate an autonomous driving mode) in the case of a high-risk factor above a certain threshold.

The method 200 can include transmitting an indication of the above-threshold predictive output to another apparatus (e.g., another self-driving car) that is within a predetermined range of the at least one sensing device or to a central server. In some examples, the method 200 includes determining a proportion of time spent by the vehicle in geographic locations with corresponding above-threshold risk values and determining or modifying an insurance premium for the vehicle based on the determined proportion of time. Such data can be used to inform transportation applications (public transportation systems), navigation systems, and the like. In some implementations, each of a plurality of vehicles in a cooperative vehicle system is configured to generate and transmit indications of above-threshold predictive outputs to other vehicles when they are within a predetermined range. In some implementations, the method 200 includes determining the predictive output and/or an appropriate corrective operation using a machine learning model, such as a trained neural network model. The neural network model can be trained based, at least in part, on historical vehicle data, traffic data, accident data, or combinations thereof.

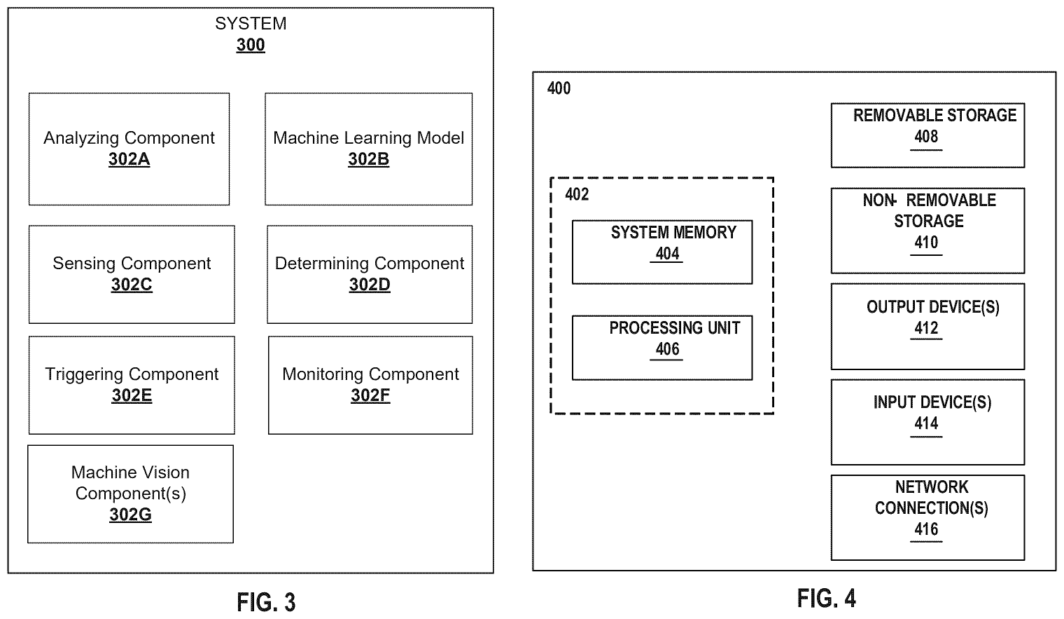

Referring now to FIG. 3, an example system 300 is shown. The system 300 can be configured to perform the method 200 described above in connection with FIG. 2. In various implementations, the system 300 is embodied as a vehicle, computing device, or remote server. For example, the system 300 may be located remotely from a vehicle, while in other embodiments, the system 300 and the vehicle may be collocated, such as within the vehicle. Each of the components of the system, may be in communication with one another over the same or different wireless or wired networks including, for example, a wired or wireless Personal Area Network (PAN), Local Area Network (LAN), Metropolitan Area Network (MAN), Wide Area Network (WAN), cellular network, and/or the like. In some embodiments, a network may comprise the automotive cloud, digital transportation infrastructure (DTI), radio data system (RDS)/high-definition radio (HD) or other digital radio system, and/or the like. For example, a vehicle may be in communication with the system 300 via the network and/or via the Cloud. In the example shown in FIG. 3, the system 300 includes analyzing component(s) 302A, machine learning model(s) 302B, sensing component(s) 302C, determining component(s) 302D, triggering component(s) 302E, monitoring component(s) 302F, and machine vision component(s) 302G.

### Example Sensing Device

As detailed herein, an example vehicle can include one or more sensing devices that in turn comprise camera(s), sensor(s), and the like.

Advanced cameras and sensors: Autonomous vehicles are increasingly being equipped with high-resolution cameras and sensors. These cameras and sensors use a variety of techniques, such as high dynamic range (HDR) imaging and adaptive exposure control.

Infrared cameras: Infrared cameras can detect heat radiation. This technology has the potential to significantly improve the performance of autonomous vehicles in various conditions.

LiDAR: LiDAR is a laser-based technology that can create a 3D map of the surrounding environment. This map can be used to identify objects and road markings.

RADAR: RADAR is a radio-based technology that can detect objects by measuring the reflection of radio waves. RADAR can be used to identify objects and road markings.

### Machine Learning

In addition to the machine learning operation described above, the exemplary system can be implemented using one or more artificial intelligence and machine learning operations. The term “artificial intelligence” can include any technique that enables one or more computing devices or comping systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, transformer-based models (e.g., Bidirectional Encoder Representations from Transformers (BERT), Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include but are not limited to artificial neural networks or multilayer perceptron (MLP).

Machine learning models include supervised, semi-supervised, and unsupervised learning models. In a supervised learning model, the model learns a function that maps an input (also known as feature or features) to an output (also known as target) during training with a labeled data set (or dataset). In an unsupervised learning model, the algorithm discovers patterns among data. In a semi-supervised model, the model learns a function that maps an input (also known as feature or features) to an output (also known as a target) during training with both labeled and unlabeled data.

Neural Networks. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tan h, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by down-sampling). A fully-connected layer includes neurons, where each neuron is connected to all of the neurons in the previous layer. The layers are stacked similar to traditional neural networks. GCNNs are CNNs that have been adapted to work on structured datasets such as graphs.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., error such as L1 or L2 loss), during training. This disclosure contemplates that any algorithm that finds the minimum of the cost function can be used. LR classifiers are known in the art and are therefore not described in further detail herein.

A Naïve Bayes' (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is an unsupervised classification model that classifies new data points based on similarity measures (e.g., distance functions). The k-NN classifiers are trained with a data set (also referred to herein as a “dataset”) to maximize or minimize a measure of the k-NN classifier's performance during training. This disclosure contemplates any algorithm that finds the maximum or minimum. The k-NN classifiers are known in the art and are therefore not described in further detail herein.

A majority voting ensemble is a meta-classifier that combines a plurality of machine learning classifiers for classification via majority voting. In other words, the majority voting ensemble's final prediction (e.g., class label) is the one predicted most frequently by the member classification models. The majority voting ensembles are known in the art and are therefore not described in further detail herein.

### Computing Devices and Methods of Use

It should be appreciated that the logical operations described herein with respect to the various figures may be implemented (1) as a sequence of computer-implemented acts or program modules (i.e., software) running on a computing device (e.g., the computing device described in FIG. 4), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special-purpose digital logic, and any combination thereof. It should also be appreciated that more or fewer operations may be performed than shown in the figures and described herein. These operations may also be performed in a different order than those described herein.

Referring to FIG. 4, an example computing device 400 upon which embodiments of the present disclosure may be implemented is illustrated. It should be understood that the example computing device 400 is only one example of a suitable computing environment upon which embodiments of the present disclosure may be implemented. Optionally, the computing device 400 can be a well-known computing system including, but not limited to, personal computers, servers, handheld or laptop devices, multiprocessor systems, microprocessor-based systems, personal network computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, the computing device 400 typically includes at least one processing unit 406 and system memory 404. Depending on the exact configuration and type of computing device, system memory 404 may be volatile (such as random-access memory (RAM)), non-volatile (such as read-only memory (ROM), flash memory, etc.), or some combination of the two. This most basic configuration is illustrated in FIG. 4 by the dashed line 402. The processing unit 406 may be a standard programmable processor that performs arithmetic and logic operations necessary for the operation of the computing device 400. The computing device 400 may also include a bus or other communication mechanism for communicating information among various components of the computing device 400.

Computing device 400 may have additional features/functionality. For example, the computing device 400 may include additional storage such as removable storage 408 and non-removable storage 410 including, but not limited to magnetic or optical disks or tapes. Computing device 400 may also contain network connection(s) 416 that allow the device to communicate with other devices. Computing device 400 may also have input device(s) 414 such as a keyboard, mouse, touch screen, etc. Output device(s) 412, such as a display, speakers, printer, etc., may also be included. The additional devices may be connected to the bus in order to facilitate communication of data among the components of the computing device 400. All these devices are well-known in the art and need not be discussed at length here.

The processing unit 406 may be configured to execute program code encoded in tangible, computer-readable media. Tangible, computer-readable media refers to any media that is capable of providing data that causes the computing device 400 (i.e., a machine) to operate in a particular fashion. Various computer-readable media may be utilized to provide instructions to the processing unit 406 for execution. Example of tangible, computer-readable media may include but is not limited to, volatile media, non-volatile media, removable media and non-removable media implemented in any method or technology for storage of information such as computer-readable instructions, data structures, program modules or other data. System memory 404, removable storage 408, and non-removable storage 410 are all examples of tangible computer storage media. Examples of tangible, computer-readable recording media include but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 406 may execute program code stored in the system memory 404. For example, the bus may carry data to the system memory 404, from which the processing unit 406 receives and executes instructions. The data received by the system memory 404 may optionally be stored on the removable storage 408 or the non-removable storage 410 before or after execution by the processing unit 406.

It should be understood that the various techniques described herein may be implemented in connection with hardware or software or, where appropriate, with a combination thereof. Thus, the methods and apparatuses of the presently disclosed subject matter, or certain embodiments or portions thereof, may take the form of program code (i.e., instructions) embodied in tangible media or removable storage media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, for example, through the use of an application programming interface (API), reusable controls, or the like. Such programs may be implemented in a high-level procedural or object-oriented programming language to communicate with a computer system. However, the program(s) can be implemented in assembly or machine language if desired. In any case, the language may be a compiled or interpreted language, and it may be combined with hardware implementations.

In one embodiment, disclosed herein is a non-transitory computer-readable storage medium comprising instructions that, when executed, cause at least one processor to perform the method of any preceding embodiments.

Although certain implementations may refer to utilizing aspects of the presently disclosed subject matter in the context of one or more stand-alone computer systems, the subject matter is not so limited but rather may be implemented in connection with any computing environment. For example, the components described herein can be hardware and/or software components in a single or distributed systems, or in a virtual equivalent, such as, a cloud computing environment. Still further, aspects of the presently disclosed subject matter may be implemented in or across a plurality of processing chips or devices, and storage may similarly be affected across a plurality of devices. Such devices might include personal computers, network servers, and handheld devices, for example.

1. A driving system comprising:
at least one vehicle, the at least one vehicle comprising:
at least one processor in electronic communication with the at least one vehicle; and
a memory having instructions thereon, wherein the instructions when executed by the processor, cause the processor to:
monitor the at least one vehicle's geographic location;
obtain data corresponding with the at least one vehicle's geographic location; 19016485
determine a predictive output indicative of a risk measure for the at least one vehicle's geographic location; and
in response to identifying an above-threshold predictive output for the at least one vehicle's geographic location, determine an optimal vehicle route, generate an alert, and/or trigger a corrective operation.

2. The driving system of claim 1, wherein the instructions when executed by the processor cause the processor to further:
provide a recommendation for a driver of the at least one vehicle to modify the at least one vehicle's route.

3. The driving system of claim 1, wherein the corrective operation comprises causing the at least one vehicle to modify its route and/or modify a vehicle driving mode.

4. The driving system of claim 1, wherein the predictive output is determined using a neural network model.

5. The driving system of claim 1, wherein the instructions when executed by the processor cause the processor to further:
determine a confidence measure in relation to the above-threshold predictive output; and
generate the alert or trigger the corrective operation in an instance in which the confidence measure meets or exceeds a predetermined threshold.

6. The driving system of claim 5, wherein the confidence measure is determined based, at least in part, on real-time vehicle data obtained from one or more other vehicles.

7. The driving system of claim 1, wherein the instructions when executed by the processor cause the processor to further:
transmit an indication of the above-threshold predictive output to another apparatus that is within a predetermined range of the at least one vehicle or to a central server.

8. The driving system of claim 1, wherein the predictive output is determined based, at least in part, on at least one of historical weather conditions, current weather conditions, time of year, historical accident data corresponding with the vehicle's geographic location and/or real-time or historical vehicle data.

9. The driving system of claim 8, wherein the real-time vehicle data comprises at least one of a vehicle speed, temperature, direction of travel, and vehicle path deviation/variance.

10. The driving system of claim 1, wherein the predictive output is determined based, at least in part, on data obtained from one or more databases.

11. The driving system of claim 1, wherein the predictive output is determined based, at least in part, on historical vehicle data for a plurality of other vehicles.

12. The driving system of claim 1, wherein the vehicle's geographic location comprises one or more public and/or private roads.

13. The driving system of claim 1, wherein the instructions when executed by the processor cause the processor to further:
update one or more existing maps and/or navigation systems based, at least in part, on the predictive output.

14. The driving system of claim 1, wherein the instructions when executed by the processor cause the processor to further:
determine a proportion of time spent by the at least one vehicle in geographic locations with corresponding above-threshold risk values; and
determine an insurance premium for the at least one vehicle based, at least in part, on the determined proportion of time.

15. The driving system of claim 1, wherein the at least one vehicle is an autonomous or semi-autonomous vehicle.

16. A cooperative driving system comprising:
a plurality of vehicles in electronic communication with one another, each vehicle comprising:
at least one image sensor;
a processor in electronic communication with the at least one image sensor; and
a memory having instructions thereon, wherein the instructions when executed by the processor, cause the processor to:
monitor each vehicle's geographic location;
obtain data corresponding with the vehicle's geographic location;
determine a predictive output indicative of a risk measure for each vehicle's geographic location; and
in response to identifying an above-threshold predictive output for a particular vehicle's current geographic location, determine an optimal vehicle route, generate an alert, and/or trigger a corrective operation,
wherein each of the plurality of vehicles is configured to transmit an indication of detected above-threshold predictive outputs to at least another vehicle and/or trigger corrective operations in relation to the at least another vehicle.

17. The cooperative driving system of claim 16, wherein each of the plurality of vehicles is configured to transmit the indication of detected above-threshold predictive outputs to at least another vehicle and/or trigger corrective operations in relation to the at least another vehicle when it is within a predetermined range.

18. The cooperative driving system of claim 17, wherein each vehicle is an autonomous or semi-autonomous vehicle.

19. A method for determining a risk measure for a vehicle's geographic location, the method comprising:
monitoring the vehicle's geographic location;
periodically determining a predictive output indicative of the risk measure for the vehicle's geographic location; and
in response to identifying an above-threshold predictive output for the vehicle's geographic location, determine an optimal vehicle route, generate an alert, and/or trigger a corrective operation.

20. (canceled)
